(19) United States
(12) Patent Application Publication
(10) Pub. No.: US 2019/0155318 A1
(43) Pub. Date: May 23, 2019

(54) TORQUE SIGNAL DYNAMIC COMPENSATION BASED ON SENSOR LOCATION

(71) Applicant: PRATT & WHITNEY CANADA CORP., Longueuil (CA)

(72) Inventor: Gabriel MEUNIER, Saint-Bruno-de-Montarville (CA)

(21) Appl. No.: 15/821,807

(22) Filed: Nov. 23, 2017

(51) Int. Cl. G05D 17/02; F02C 3/113; F02C 7/36; F02C 9/28

(52) U.S. Cl. CPC G05D 17/02; F02C 3/113; F02C 7/36; F02C 9/28; F05D 2270/335; F05D 2200/13; F05D 2260/4031; F05D 2270/052; F05D 2270/06; F05D 2200/11; F05D 2270/52

(57) ABSTRACT

Herein provided are methods and systems for operating a gas-turbine engine comprising a gearbox and a power turbine coupled to the gearbox. A first torque at the gearbox is obtained via a sensor. A second torque at the power turbine is determined based on the first torque. A power at the power turbine is determined based on the second torque. Operation of the engine is controlled based on the power.

### TECHNICAL FIELD

The present disclosure relates to control systems for gas turbine engines.

### BACKGROUND OF THE ART

Control systems for a gas turbine engine consider a variety of parameters when regulating the operation of the engine. These parameters are collected via sensors, which may be actual physical sensors or virtual sensors, which use other measurements to derive the desired parameter. One such parameter is a value of torque output by the engine. Since output torque is representative of a value of output power, measuring output torque is useful for regulating fuel flow to the engine. In addition, if the torque exceeds a particular limit, one or more components of the engine may be damaged, requiring maintenance and/or repairs.

Traditional approaches at measuring the torque at the gearbox rely on measuring torque at an output shaft of the engine, whether directly or via a virtual sensor. However, depending on the nature of the load connected to the output shaft, changes in behaviour of the load may interact with measurements of output torque, thereby failing to provide an accurate measurement.

Thus, improvements may be needed.

### SUMMARY

In accordance with a broad aspect, there is provided a method for operating a gas-turbine engine comprising a gearbox and a power turbine coupled to the gearbox. The method comprises: obtaining, via a sensor, a first torque at the gearbox; determining a second torque at the power turbine based on the first torque; determining a power at the power turbine based on the second torque; and controlling operation of the engine based on the power.

In some embodiments, the sensor is a virtual sensor.

In some embodiments, determining the second torque is further based on an acceleration of a shaft of the power turbine and a rotational inertia of the shaft.

In some embodiments, determining the second torque is based on the equation Qₚₜ=Qₛ+\dot{N}ₚₜ·Iₚₜ, where Q^{pt} is the second torque, Qₛ is the first torque, \dot{N}ₚₜ is the acceleration of the shaft, and Iₚₜ is the rotational inertia of the shaft.

In some embodiments, determining the power is further based on a speed of a shaft of the power turbine.

In some embodiments, determining the power is based on the equation SHPₚₜ=Qₚₜ·Nₚₜ·k, where SHPₚₜ is the power, Qₚₜ is the second torque, and Nₚₜ is the speed of the shaft, and k is a predetermined constant.

In some embodiments, controlling operation of the engine comprises adjusting a fuel flow to the engine.

In some embodiments, controlling operation of the engine comprises adjusting a blade angle of a propeller coupled to the engine.

In some embodiments, the method further comprises comparing at least one of the first torque and the second torque to associated torque limits, wherein controlling operation of the engine comprises preventing the at least one of the first torque and the second torque from surpassing the associated torque limits.

In some embodiments, the engine is for an aircraft, further comprising displaying, to an operator of the aircraft, at least one of the second torque and the power.

In accordance with another broad aspect, there is provided an engine control system for a gas-turbine engine comprising a gearbox and a power turbine coupled to the gearbox, the system comprising: a sensor configured for obtaining a first torque at the gearbox; a processing unit communicatively coupled to the sensor; and a non-transitory computer-readable memory communicatively coupled to the processing unit and comprising computer-readable program instructions. The program instructions are executable by the processing unit for: determining a second torque at the power turbine based on the first torque; determining a power at the power turbine based on the second torque; and controlling operation of the engine based on the power.

In some embodiments, the sensor is a virtual sensor.

In some embodiments, determining the second torque is further based on an acceleration of a shaft of the power turbine and a rotational inertia of the shaft.

In some embodiments, determining the second torque is based on the equation Qₚₜ=Qₛ+\dot{N}ₚₜ·Iₚₜ, where Qₚₜ is the second torque, Qₛ is the first torque, \dot{N}ₚₜ is the acceleration of the shaft, and Iₚₜ is the rotational inertia of the shaft.

In some embodiments, determining the power is further based on a speed of a shaft of the power turbine.

In some embodiments, determining the power is based on the equation SHPₚₜ=Qₚₜ·Nₚₜ·k, where SHPₚₜ is the power, Qₚₜ is the second torque, Nₚₜ is the speed of the shaft, and k is a predetermined constant.

In some embodiments, controlling operation of the engine comprises adjusting a fuel flow to the engine.

In some embodiments, controlling operation of the engine comprises adjusting a blade angle of a propeller coupled to the engine.

In some embodiments, the program instructions are further executable by the processing unit for comparing at least one of the first torque and the second torque to associated torque limits, wherein controlling operation of the engine comprises preventing the at least one of the first torque and the second torque from surpassing the associated torque limits.

In some embodiments, the engine is for an aircraft, wherein the program instructions are further executable by the processing unit for displaying, to an operator of the aircraft, at least one of the second torque and the power.

### BRIEF DESCRIPTION OF THE DRAWINGS

Reference is now made to the accompanying figures in which:

FIG. 1 is a schematic cross-sectional view of an example gas turbine engine;

FIG. 2 is a block diagram of the gas turbine engine of FIG. 1;

FIG. 3 is a flowchart illustrating an example method for controlling the engine of FIG. 1, in accordance with an embodiment; and

FIG. 4 is a block diagram of an example computer system for implementing the method of FIG. 3.

It will be noted that throughout the appended drawings, like features are identified by like reference numerals.

### DETAILED DESCRIPTION

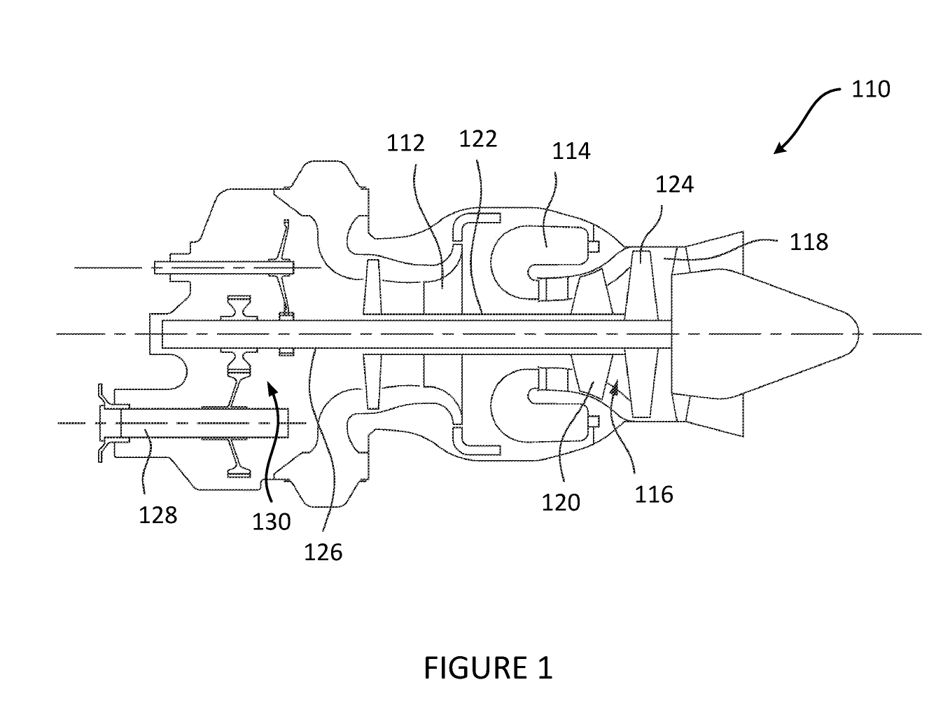

FIG. 1 illustrates a gas turbine engine 110 of a type preferably provided for use in subsonic flight, generally comprising in serial flow communication, a compressor section 112 for pressurizing the air, a combustor 114 in which the compressed air is mixed with fuel and ignited for generating an annular stream of hot combustion gases, and a turbine section 116 for extracting energy from the combustion gases. The combustion gases flowing out of the combustor 114 circulate through the turbine section 116 and are expelled through an exhaust duct 118. The turbine section 116 includes a compressor turbine 120 in driving engagement with the compressor section 112 through a high pressure shaft 122, and a power turbine 124 in driving engagement with a power shaft 126. The power shaft 126 is in driving engagement with an output shaft 128 through a gearbox 130, which may be a reduction gearbox.

Although illustrated as a turboshaft engine, the gas turbine engine 110 may alternatively be another type of engine, for example a turbofan engine, also generally comprising in serial flow communication a compressor section, a combustor, and a turbine section, and a fan through which ambient air is propelled. A turboprop engine may also apply. In addition, although the engine 110 is described herein for flight applications, it should be understood that other uses, such as industrial or the like, may apply.

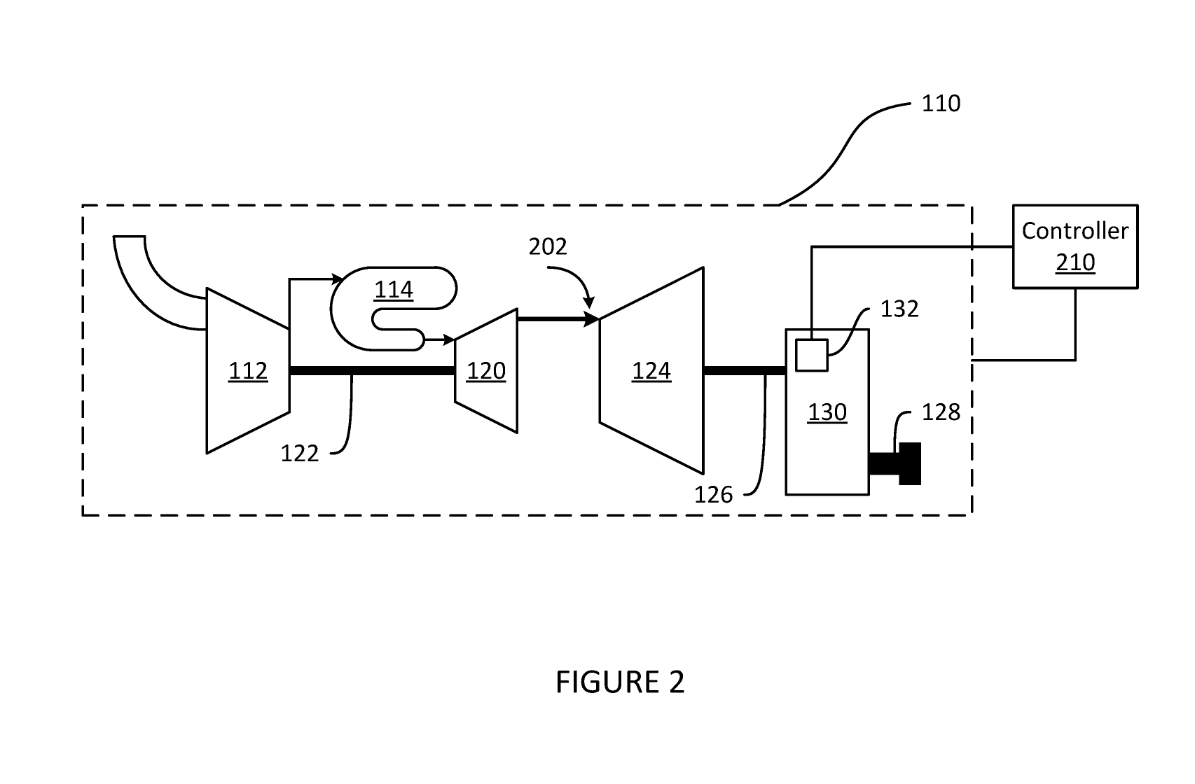

With reference to FIG. 2, the gas turbine engine 110 of FIG. 1 is reproduced in block diagram form. The engine 110 is configured for being controlled by a controller 210, which may be a full-authority digital engine controls (FADEC) or other similar device, including an electronic engine control (EEC), an engine control unit (EUC), a combination of various actuators, and the like. In some embodiments, the controller 210 is configured for regulating a fuel flow to the engine 110 based on one or more parameters measured from the engine 110. In other embodiments, the controller 210 is configured for adjusting one or more parameters associated with a load of the engine 110. For example, the controller 210 adjusts a feathering level of a propeller coupled to the engine (e.g. via the output shaft 128), for instance by communicating one or more instructions to a propeller controller. In another example, the controller 210 adjusts a blade angle of the propeller. In addition, located at the gearbox 130 is a torque sensor 132 for measuring a first torque produced by the engine 110 at the gearbox 130. The sensor 132 is configured for providing the controller 210 with the first torque produced by the engine 110. The sensor 132 provides the controller 210 with the first torque via one or more wired connections, via one or more wireless connections, or any suitable combination thereof.

In some embodiments, the sensor 132 is a physical sensor located at a position proximate to or within the gearbox 130. Thus, the expression “at the gearbox” refers to any suitable location proximate to or within the gearbox 130. For example, the sensor 132 is located at a coupling point between the power shaft 126 and the gearbox 130. In another example, the sensor 132 is located near one or more gears within the gearbox 130. In a further example, the sensor 132 is located proximate to a coupling point between the gearbox 130 and the output shaft 128. The sensor 132 may be any suitable torque sensor.

In some other embodiments, the sensor 132 is a virtual sensor which is considered to be “located at” the gearbox 130 insofar as the virtual sensor 132 is configured for determining a value of the first torque at the gearbox 130, even though the sensor value is derived in a computing system which, in some embodiments, is located remotely from the gearbox 130. The sensor 132 may use any suitable values which may be collected from one or more physical sensors and/or one or more further virtual sensors at different locations throughout the engine 110.

The controller 210 is configured for using the first torque to determine a second torque. The second torque value is a value representative of the torque produced by the engine at point 202, namely at the power turbine 124. The point 202 can be located within the power turbine 124, at a coupling point between the power turbine and a shaft or other mechanical implement linking the power turbine 124 to the compressor turbine 120, or any other suitable location proximate the power turbine 124. The second torque can be determined by treating the power turbine and power shaft 126 as a rigid body. In some embodiments, the second torque is also based on an acceleration of the power shaft 126 and a rotational inertia of the power shaft 126. For example, the second torque can be determined using the equation:

Qₚₜ=Qₛ+\dot{N}ₚₜ·Iₚₜ,

where Qₚₜ is the second torque, Qₛ is the first torque, \dot{N}ₚₜ is the acceleration of the power shaft 126, and Iₚₜ is the rotational inertia of the power shaft 126. Thus, by using the relevant kinematics equation, the second torque, at point 202 near the power turbine 124, can be determined.

The controller 210 is also configured for using the second torque to determine a power produced by the engine at the power turbine 124, which can be used as a measure of the output power of the engine 110. In some embodiments, the power is also based on a speed of the power shaft 126. For example, the power can be determined using the equation:

SHPₚₜ=Qₚₜ·Nₚₜ·k,

where SHPₚₜ is the power at the power turbine, Qₚₜ is the second torque, Nₚₜ is the speed of the power shaft 126, and k is a predetermined constant. Thus, by using the relevant kinematics equation, the power, at point 202 near the power turbine 124, can be determined.

Because the second torque is mathematically translated from the gearbox to the power turbine, it is decoupled from the load attached to the engine and changes in the operation of the load do not affect the value of the second torque, or the value of the power. Thus, the second torque can be used to determine the amount of power output by the engine 110 without being influenced by the load attached to the engine.

The controller 210 is further configured for controlling operation of the engine 110 based on the power. In some embodiments, the controller 210 controls a fuel flow to the engine and/or a feathering level of a propeller coupled to the engine as part of power governing for the engine 110 and/or propeller governing for the propeller. Still other control schemes are considered. In some other embodiments, the controller 210 is configured to control operation of the engine 110 to ensure that predetermined limits of power, torque, speed, acceleration, and the like are not exceeded, for example as part of torque governing for the engine 110 to reduce the risk of damage to the gearbox 130. For example, the controller 210 is further configured for receiving input from an operator of the engine 110 and for adjusting the operation of the engine 110 in consequence. In some embodiments, the controller 210 is configured for displaying one or more of the first torque, the second torque, and the power to the operator of the engine 110, for example an operator of an aircraft to which the engine 110 belongs.

In another example, a predetermined limit for the first torque, at the gearbox 130, and/or a predetermined limit for the second torque, at the power turbine 124, are set by a manufacturer or operator of the engine 110. The controller 210 is configured for comparing the first torque and/or the second torque to the respective limits and to control operation of the engine 110 to ensure that the limits are not exceeded. Similarly, the controller 210 may be provided with other limits and ensure that the engine 110 operates within those limits.

In some embodiments, the power at the power turbine can be used as part of a power control feedback loop. The two equations described hereinabove can be implemented via an engine controller, for example the controller 210, which measures or otherwise obtains the first torque Qₛ, via a sensor, for example the sensor 132. The controller 210 can obtain the power shaft acceleration \dot{N}ₚₜ by performing a finite time differentiation of the power shaft speed Nₚₜ, and the rotational inertia Iₚₜ of the shaft portion from power turbine to the sensor location can be a constant stored in the engine controller or a memory thereof. The power control feedback loop implemented by the controller 210 and using the power SHPₚₜ calculated at the power turbine can thus be used to control operation of the engine 110.

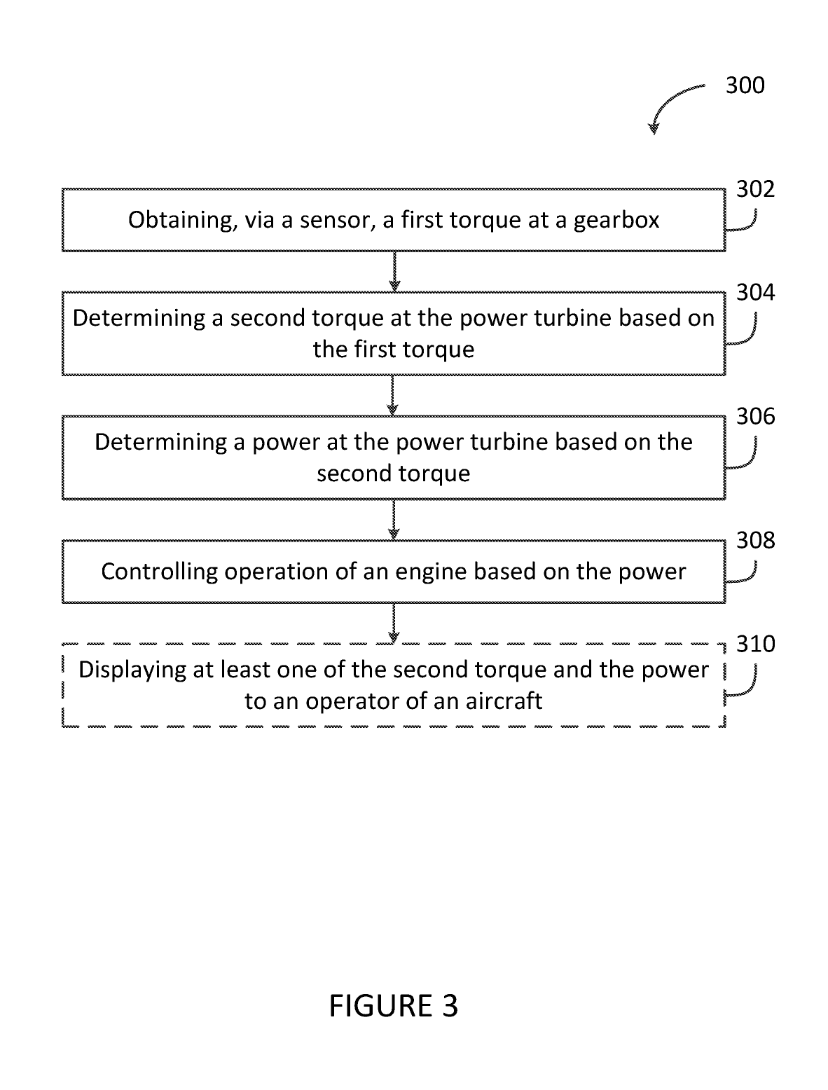

With reference to FIG. 3, a method 300 for operating a gas-turbine engine comprising a gearbox and a power turbine coupled to the gearbox, for example the engine 110 having the gearbox 130 and the power turbine 124, is provided. At step 302, a first torque at the gearbox 130 is obtained via a sensor, for example the sensor 132.

At step 304, a second torque at the power turbine 124 is determined based on the first torque. In some embodiments, the second torque is also based on an acceleration of a power shaft, for example the power shaft 126, and on a rotational inertia of the power shaft 126. At step 306, a power at the power turbine 124 is determined based on the second torque. In some embodiments, the power is also based on a speed of the power shaft 126.

At step 308, operation of the engine is controlled based on the power. For example, the fuel flow to the engine and/or one or more parameters of a load coupled to the engine 110 are adjusted. Optionally, at step 310, one of the second torque and the power is displayed to an operator of the engine 110, for example an operator of the aircraft to which the engine 110 belongs.

It should be noted that the translation of the torque from the gearbox 130 to the power turbine 124 can be performed across any number of mechanical components disposed between the output shaft 128 to which the gearbox 130 is connected and the power turbine 124. For instance, the translation of the torque can be performed for two spool engines, three spool engines, or engines having any other suitable number of spools. In addition, the translation of the torque can be performed across any number of shafts or other linkages disposed between the output shaft 128 and the power turbine 124.

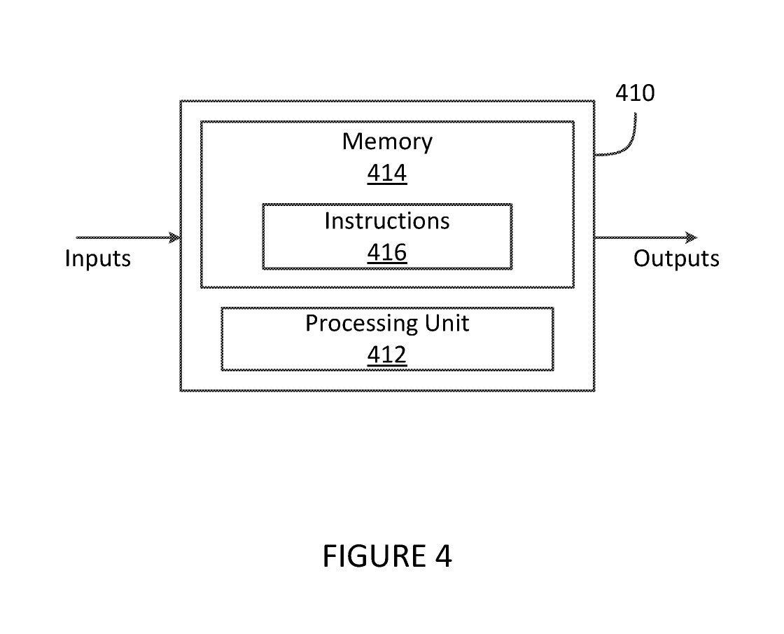

With reference to FIG. 4, the method 300 may be implemented by a computing device 410, comprising a processing unit 412 and a memory 414 which has stored therein computer-executable instructions 416. For example, the controller 210 may be embodied as the computing device 410. The processing unit 412 may comprise any suitable devices configured to implement the method 300 such that instructions 416, when executed by the computing device 410 or other programmable apparatus, may cause the functions/acts/steps performed as part of the method 300 as described herein to be executed. The processing unit 412 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory 414 may comprise any suitable known or other machine-readable storage medium. The memory 414 may comprise non-transitory computer readable storage medium, for example, but not limited to, an electronic, magnetic, optical, electromagnetic, infrared, or semiconductor system, apparatus, or device, or any suitable combination of the foregoing. The memory 414 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 414 may comprise any storage means (e.g., devices) suitable for retrievably storing machine-readable instructions 416 executable by processing unit 412.

It should be noted that the controller 210, as implemented by the computing device 410, may be implemented as part of a full-authority digital engine controls (FADEC) or other similar device, including electronic engine control (EEC), engine control unit (EUC), various actuators, and the like.

The methods and systems for operating a gas-turbine engine comprising a gearbox and a power turbine coupled to the gearbox described herein may be implemented in a high level procedural or object oriented programming or scripting language, or a combination thereof, to communicate with or assist in the operation of a computer system, for example the computing device 410. Alternatively, the methods and systems described herein may be implemented in assembly or machine language. The language may be a compiled or interpreted language. Program code for implementing the methods and systems described herein may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems described herein may also be considered to be implemented by way of a non-transitory computer-readable storage medium having a computer program stored thereon. The computer program may comprise computer-readable instructions which cause a computer, or more specifically the processing unit 412 of the computing device 410, to operate in a specific and predefined manner to perform the functions described herein, for example those described in the method 300.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure.

Various aspects of the methods and systems described herein may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be apparent to those skilled in the art that changes and modifications may be made without departing from this invention in its broader aspects. The scope of the following claims should not be limited by the embodiments set forth in the examples, but should be given the broadest reasonable interpretation consistent with the description as a whole.

1. A method for operating a gas-turbine engine comprising a gearbox and a power turbine coupled to the gearbox, the method comprising:
obtaining, via a sensor, a first torque at the gearbox;
determining a second torque at the power turbine based on the first torque;
determining a power at the power turbine based on the second torque; and
controlling operation of the engine based on the power.

2. The method of claim 1, wherein the sensor is a virtual sensor.

3. The method of claim 1, wherein determining the second torque is further based on an acceleration of a shaft of the power turbine and a rotational inertia of the shaft.

4. The method of claim 3, wherein determining the second torque is based on the equation Qₚₜ=Qₛ+\dot{N}ₚₜ·Iₚₜ, where Qₚₜ is the second torque, Qₛ is the first torque, \dot{N}ₚₜ is the acceleration of the shaft, and Iₚₜ is the rotational inertia of the shaft.

5. The method of claim 1, wherein determining the power is further based on a speed of a shaft of the power turbine.

6. The method of claim 5, wherein determining the power is based on the equation SHPₚₜ=Qₚₜ·Nₚₜ·k, where SHPₚₜ is the power, Qₚₜ is the second torque, Nₚₜ is the speed of the shaft, and k is a predetermined constant.

7. The method of claim 1, wherein controlling operation of the engine comprises adjusting a fuel flow to the engine.

8. The method of claim 1, wherein controlling operation of the engine comprises adjusting a blade angle of a propeller coupled to the engine.

9. The method of claim 1, further comprising comparing at least one of the first torque and the second torque to associated torque limits, wherein controlling operation of the engine comprises preventing the at least one of the first torque and the second torque from surpassing the associated torque limits.

10. The method of claim 1, wherein the engine is for an aircraft, further comprising displaying, to an operator of the aircraft, at least one of the second torque and the power.

11. An engine control system for a gas-turbine engine comprising a gearbox and a power turbine coupled to the gearbox, the system comprising:
a sensor configured for obtaining a first torque at the gearbox;
a processing unit communicatively coupled to the sensor; and
a non-transitory computer-readable memory communicatively coupled to the processing unit and comprising computer-readable program instructions executable by the processing unit for:
determining a second torque at the power turbine based on the first torque;
determining a power at the power turbine based on the second torque; and
controlling operation of the engine based on the power.

12. The system of claim 11, wherein the sensor is a virtual sensor.

13. The system of claim 11, wherein determining the second torque is further based on an acceleration of a shaft of the power turbine and a rotational inertia of the shaft.

14. The system of claim 13, wherein determining the second torque is based on the equation Qₚₜ=Qₛ+\dot{N}ₚₜ·Iₚₜ, where Qₚₜ is the second torque, Qₛ is the first torque, \dot{N}ₚₜ is the acceleration of the shaft, and Iₚₜ is the rotational inertia of the shaft.

15. The system of claim 11, wherein determining the power is further based on a speed of a shaft of the power turbine.

16. The system of claim 15, wherein determining the power is based on the equation SHPₚₜ=Qₚₜ·Nₚₜ·k, where SHPₚₜ is the power, Qₚₜ is the second torque, Nₚₜ is the speed of the shaft, and k is a predetermined constant.

17. The system of claim 11, wherein controlling operation of the engine comprises adjusting a fuel flow to the engine.

18. The system of claim 11, wherein controlling operation of the engine comprises adjusting a blade angle of a propeller coupled to the engine.

19. The system of claim 11, wherein the program instructions are further executable by the processing unit for comparing at least one of the first torque and the second torque to associated torque limits, wherein controlling operation of the engine comprises preventing the at least one of the first torque and the second torque from surpassing the associated torque limits.

20. The system of claim 11, wherein the engine is for an aircraft, wherein the program instructions are further executable by the processing unit for displaying, to an operator of the aircraft, at least one of the second torque and the power.
